(19) United States
(12) Patent Application Publication
(10) Pub. No.: US 2015/0239710 A1
(43) Pub. Date: Aug. 27, 2015

(54) LOW FRICTION SLIDING GUIDE SHOE FOR ELEVATOR

(71) Applicant: OTIS ELEVATOR COMPANY, Farmington,, CT (US)

(72) Inventors: Franck Det, Briare (FR); Pascal Rebillard, Gien (FR); Christèle Gressien, Chatilon Coligny (FR)

(73) Assignee: OTIS ELEVATOR COMPANY, Farmington, CT (US)

(21) Appl. No.: 14/433,911

(22) PCT Filed: Oct. 8, 2012
(86) PCT No.: PCT/IB2012/002453

§ 371 Date: Apr. 7, 2015

(51) Int. Cl. B66B 7/04

(52) U.S. Cl. CPC B66B 7/047

(57) ABSTRACT

A sliding guide shoe for an elevator is provided including a base having a plurality of walls. A contact liner has a first side operably connected to at least one of the plurality of walls. A second side of the contact liner is configured to contact at least one surface on an elevator guide rail. The contact liner has a non-uniform thickness and is thereby configured to contact the at least one surface of the elevator guide rail over less than an entire surface of the second side of the contact liner.

### BACKGROUND OF THE INVENTION

Embodiments of this invention generally relate to elevator systems, and more particularly, to sliding guide shoe shoes used in elevator systems.

Sliding guide shoes (also known as slide guides, or guide shoes) are used in elevator systems to safely guide elevator cars through hoistways. Conventional sliding guide shoes include flat linings configured to engage corresponding guide rails to limit the horizontal motion of elevator cars while they are traveling vertically in their respective hoistways. During operation of a typical elevator system, friction between the sliding guide shoes and the guide rails negatively impacts ride quality due to the transfer of noise and vibrations from the guide rails to the elevator car. Excessive friction between the guide shoes and the guide rails can also cause the guide shoes or guide rails to degrade, further decreasing ride quality. Additionally, friction between the guide shoes and the rails can result in sticking or jerking, further lowering the level of ride quality and increasing the amount of power required to move the elevator cars. Typical maintenance procedures require the periodic application of lubricants to mitigate the adverse effects of the friction; this can add significant costs over time.

### SUMMARY OF THE INVENTION

According to an exemplary embodiment of the invention, a sliding guide shoe for an elevator is provided including a base having a plurality of walls. A contact liner has a first side operably connected to at least one of the plurality of walls. A second side of the contact liner is configured to contact at least one surface on an elevator guide rail. The contact liner has a non-uniform thickness and is thereby configured to contact the at least one surface of the elevator guide rail over less than an entire surface of the second side of the contact liner.

Alternatively, in this or other embodiments of the invention, the contact liner is configured to contact the at least one surface of the elevator guide rail along a line.

Alternatively, in this or other embodiments of the invention, the contact liner is configured to contact the at least one surface of the elevator guide rail at a point. The point has an area less than 25% of the entire surface of the second side.

Alternatively, in this or other embodiments of the invention, the base is generally U-shaped.

Alternatively, in this or other embodiments of the invention, the sliding guide shoe includes a plurality of contact liners.

Alternatively, in this or other embodiments of the invention, the contact liner is curved in a plurality of directions.

Alternatively, in this or other embodiments of the invention, the contact liner is configured to contact at least one surface of the elevator guide rail at a plurality of contact areas.

Alternatively, in this or other embodiments of the invention, the first side of the contact liner is removably affixed to one of the plurality of walls.

Alternatively, in this or other embodiments of the invention, at least one of the plurality of walls is curved in a first direction.

Alternatively, in this or other embodiments of the invention, at least one of the plurality of walls is curved in a plurality of directions.

According to another embodiment of the invention, an elevator system is provided including an elevator car. At least one elevator guide rail is provided along which the elevator car is configured to move. A sliding guide shoe includes a base having a plurality of walls. The sliding guide shoes also include a contact liner having a first side operably connected to at least one of the plurality of walls. A second side of the contact liner is configured to contact at least one surface on an elevator guide rail. The contact liner has a non-uniform thickness and is thereby configured to contact the at least one surface of the elevator guide rail over less than an entire surface of the second side of the contact liner.

Alternatively, in this or other embodiments of the invention, the contact liner is configured to contact the at least one surface of the elevator guide rail along a line.

Alternatively, in this or other embodiments of the invention, the contact liner is configured to contact the at least one surface of the elevator guide rail at a point. The point has an area less than 25% of the entire surface of the second side.

Alternatively, in this or other embodiments of the invention, the contact liner is curved in a plurality of directions.

Alternatively, in this or other embodiments of the invention, the contact liner is configured to contact at least one surface of the elevator guide rail at a plurality of contact areas.

Alternatively, in this or other embodiments of the invention, the first side of the contact liner is removably affixed to one of the plurality of walls of the base.

According to another embodiment of the invention, a slide member liner for sliding along a blade of a guide rail in an elevator hoistway is provided including a plurality of walls that define an interior recess therebetween for receiving the blade of the guide rail. At least one of the plurality of walls has a non-uniform thickness such that only a portion of the at least one wall is configured to engage a surface of the blade.

Alternatively, in this or other embodiments of the invention, the at least one wall is configured to engage a surface of the blade along a line.

Alternatively, in this or other embodiments of the invention, the at least one wall is configured to engage a surface of the blade at a point.

Alternatively, in this or other embodiments of the invention, the at least one wall is configured to engage a surface of the blade at a plurality of contact areas.

While various features and structures are described and depicted in conjunction with specific embodiments of the invention, these features and structures are not limited to use with the specific embodiments with which they are described. Instead, these features and structures may be combined with any of the other disclosed embodiments of the invention where practicable.

### BRIEF DESCRIPTION OF THE DRAWINGS

The foregoing and other features and advantages of the invention are apparent from the following detailed description taken in conjunction with the accompanying drawings in which:

FIG. 1 is a front view of a portion of an exemplary elevator system;

FIG. 2 is a cross-section of a known sliding guide shoe configured for use with an elevator system;

FIG. 3 is a cross-section of a sliding guide shoe according to an embodiment of the invention;

FIG. 4 is a perspective view of a slide member liner of a sliding guide shoe according to an exemplary embodiment of the invention;

FIG. 5 is a cross-section of another sliding guide shoe according to an exemplary embodiment of the invention;

FIG. 6 is a cross-section of the sliding guide shoe of FIG. 5.

FIG. 7 is a cross-section of a sliding guide shoe according to an embodiment of the invention;

FIG. 8 is a cross-section of a sliding guide shoe according to an embodiment of the invention;

FIG. 9 is a cross-section of a sliding guide shoe according to an embodiment of the invention; and

FIG. 10 is a cross-section of a sliding guide shoe according to an embodiment of the invention.

The detailed description of the invention describes exemplary embodiments of the invention, together with some of the advantages and features thereof, by way of example with reference to the drawings.

### DETAILED DESCRIPTION OF THE INVENTION

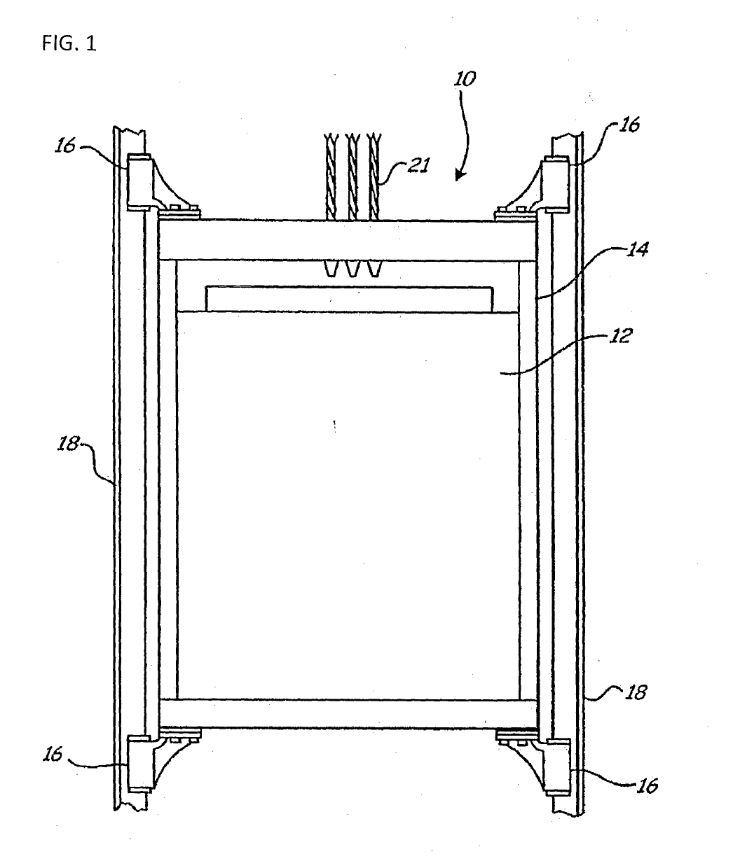

Referring now to FIG. 1, a side view of a portion of an elevator system 10 is illustrated. The elevator system 10 includes a car 12, a frame 14, sliding guide shoes 16, guide rails 18, and tensions members 21. While the tension members are depicted as round cables, alternate members such as coated belts may be used without departing from the scope of the invention. As shown in FIG. 1, the elevator car is mounted within the frame 14. Multiple sliding guide shoes 16 are connected to the frame 14, and thereby to the car 12, at the corners of the frame 14, and are movably connected to the rails 18. The number and location of the sliding guide shoes 16 and the connection between the sliding guide shoes 16 and the car 12 may vary. For example, in one embodiment of the invention, the elevator system 10 may include two sliding guide shoes 16 positioned directly between the top of the car 12 and the rails 18. In alternative embodiments of the invention, the sliding guide shoes 16 may be attached directly to the car 12, and the frame 14 may be omitted. The tension members 21 are commonly connected to a drive system (not shown), for example a hoisting machine, which drives the car 12 and the frame 14 in a hoistway (not shown) along the rails 18 via the sliding guide shoes 16. As further detailed below, the sliding guide shoes 16 may be configured to provide a low friction connection to the rails 18 to dampen vibration and structure borne noise transmitted through the system 10 to the frame 14, and thereby the car 12. Although a particular elevator system is illustrated and described in the disclosed embodiment, other configurations and/or systems, such as frame-less elevator systems are within the scope of the present invention.

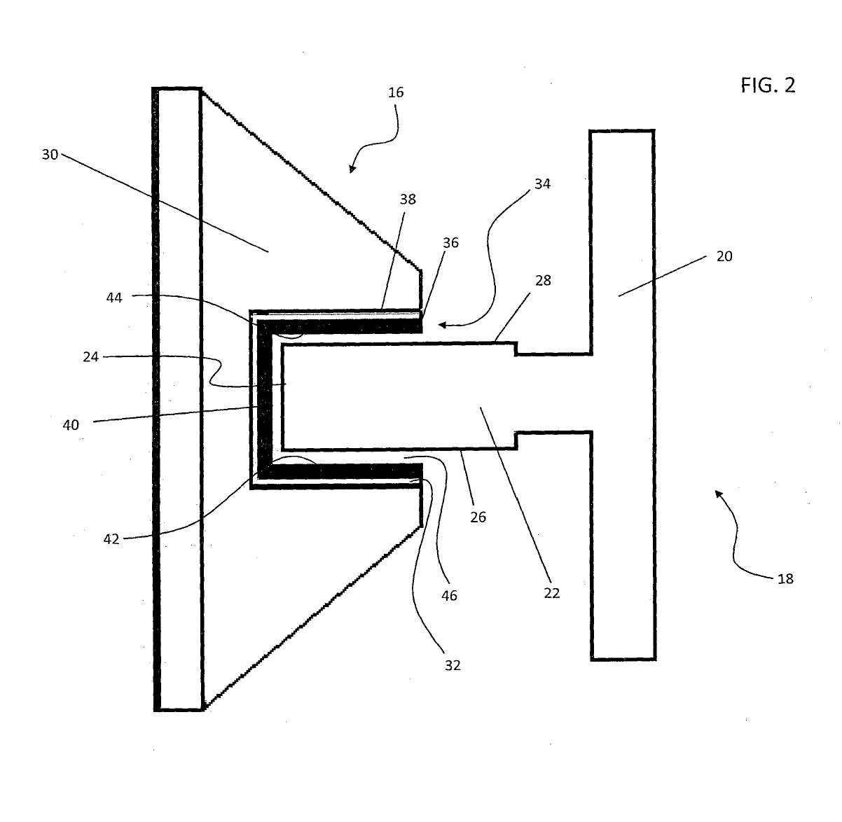

Referring now to FIG. 2, a conventional sliding guide shoe 16 and guide rail 18 are illustrated in more detail. The guide rail 18 includes a base 20 and a blade 22 extending perpendicularly from the base 20. The blade 20 is generally rectangular and includes a tip 24 and two opposing side surfaces 26, 28. The sliding guide shoe 16 includes a holding shoe 30 with a generally U-shaped slide member 34 located inside a longitudinal recess 32. The slide member 34 comprises a slide member liner 36 constructed from a first type of material and an optional intermediate layer 38 constructed from a second, different type of material. The slide member liner 36 and the intermediate layer 38 are firmly bonded together at their junction to form a unitary body. The material of the slide member liner 36 is selected from those having good resistance to abrasion and low friction such as certain elastomers and polyamides. The material used for the intermediate layer 38 may include a cellular material such as cellular polyurethane. The generally U-shaped slide member liner 36 includes a back wall 40 and two opposing sidewalls 42, 44 which define a recess 46 therebetween.

When installed in the elevator system 10, the blade 22 of the guide rail 18 is located within the recess 46 of the slide member 34. The first sidewall 42 of the slide member 34 is adjacent the first side surface 26 of the blade 22, the second sidewall 44 is adjacent the second, opposite, side surface 28 of the blade 22, and the back wall 40 is adjacent the tip 24 of the blade 22. As the elevator car 12 moves vertically in the hoistway along the guide rails 18, one or more walls 40, 42, 44 of the slide member 34 slidably engages a respective surface 24, 26, 28 of the blade 22 such that forces and vibrations may be transmitted to the slide member 34 from a rail 18.

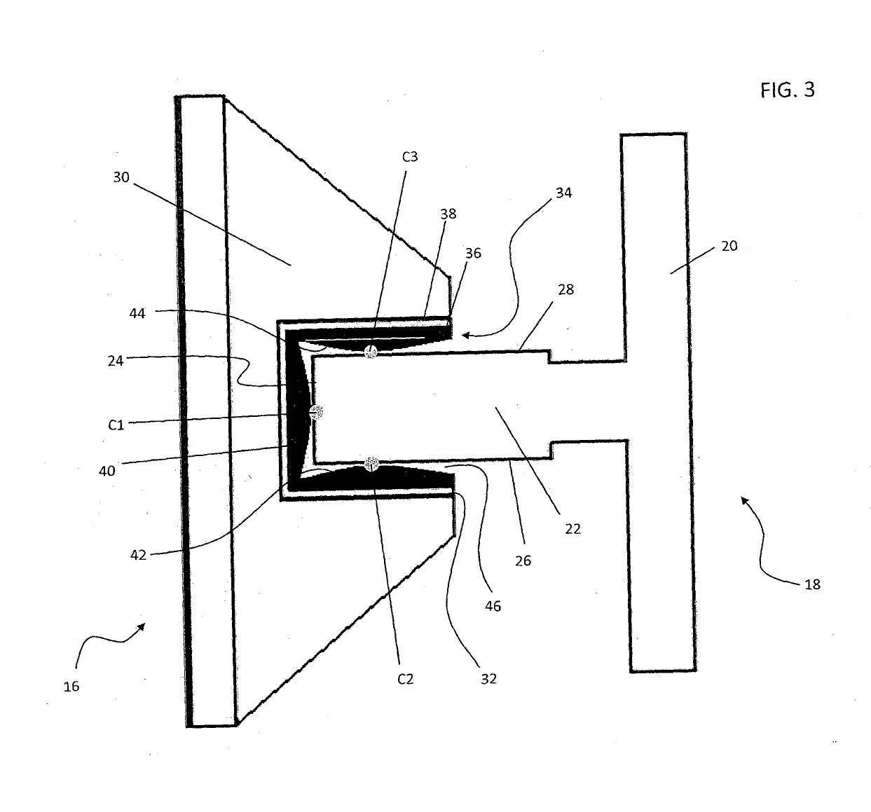

As depicted in an exemplary embodiment of the invention shown in FIG. 3, at least one of the walls 40, 42, 44 of the slide member liner 36 may have a variable thickness such that only a portion of the wall contacts a respective surface 24, 26, 28 of the guide rail blade 22. By reducing the area of contact between the slide member liner 36 and the blade 22, the friction is similarly reduced. As shown, the thickness of the at least one wall 40, 42, 44 may vary in a first direction, such as the direction of the recess 46 for example, such that the contact between that wall 40, 42, 44 and a respective surface 24, 26, 28 of the blade 22 occurs along a line. In one embodiment, the varying thickness of the at least one wall in a first direction results in that wall having a generally convex curvature. Each of the walls 40, 42, 44 of the slide member liner 36 shown in FIG. 3 has a uniform cross-section taken along a second direction, perpendicular to the first direction. For example, the thickness of a cross-section of each of the walls 40, 42, 44 is uniform along the length of the slide member 34 such that the line of contact C1, C2, C3 formed between each wall 40, 42, 44 and a respective surface 24, 26, 28 of the blade 22 is parallel to the length of the slide member 34.

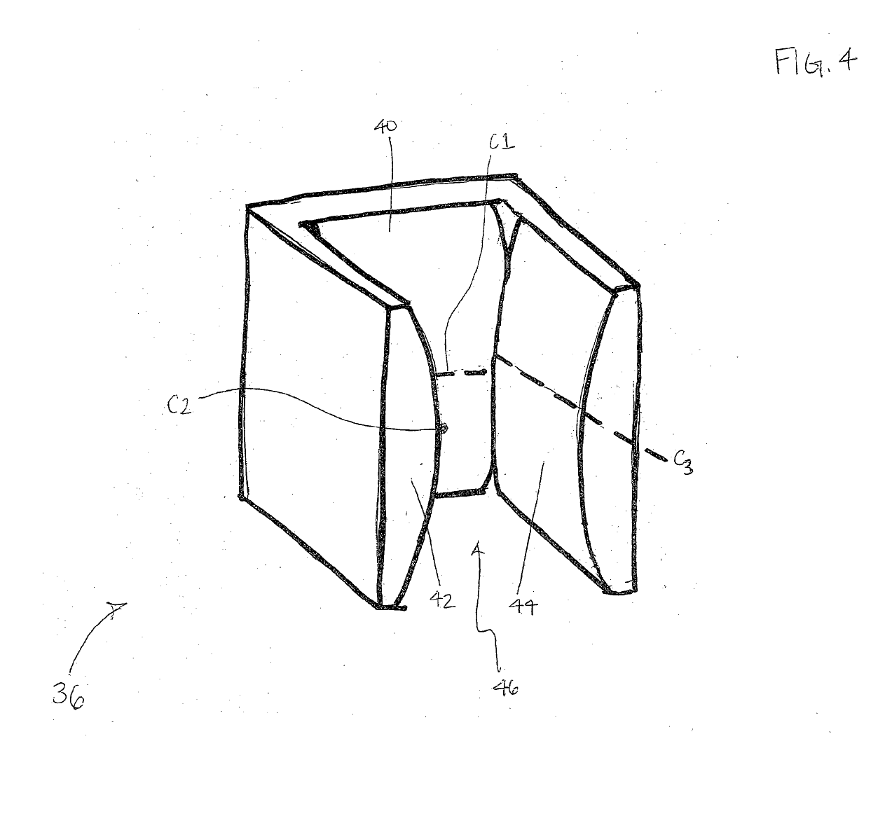

The walls 40, 42, 44 of the slide member liner 36 illustrated in FIG. 4, similarly have a thickness variable in a first direction and uniform in a second direction. In the illustrated embodiment, the cross-section of each wall 40, 42, 44 is uniform along the width of that wall 40, 42, 44 such that the line of contact C1, C2, C3 formed between each wall 40, 42, 44 and a respective surface 24, 26, 28 of the blade 22 is perpendicular to the length of the slide member 34. In addition, the line of contact C1 formed between the back wall 40 and the tip 24 is perpendicular to the line of contact C2 formed between the first side wall 42 and the first side surface 26 and the line of contact C3 formed between the second side wall 44 and the second side surface 28.

In an alternate embodiment, at least one of the walls 40, 42, 44 of the slide member liner 36 has a non-uniform thickness in both a first direction and a second direction such that the contact between that wall 40, 42, 44 and a respective surface 24, 26, 28 of the blade 22 occurs at a point. In one embodiment, the point has an area less than 25% of the entire surface of the wall 40; 42, 44.

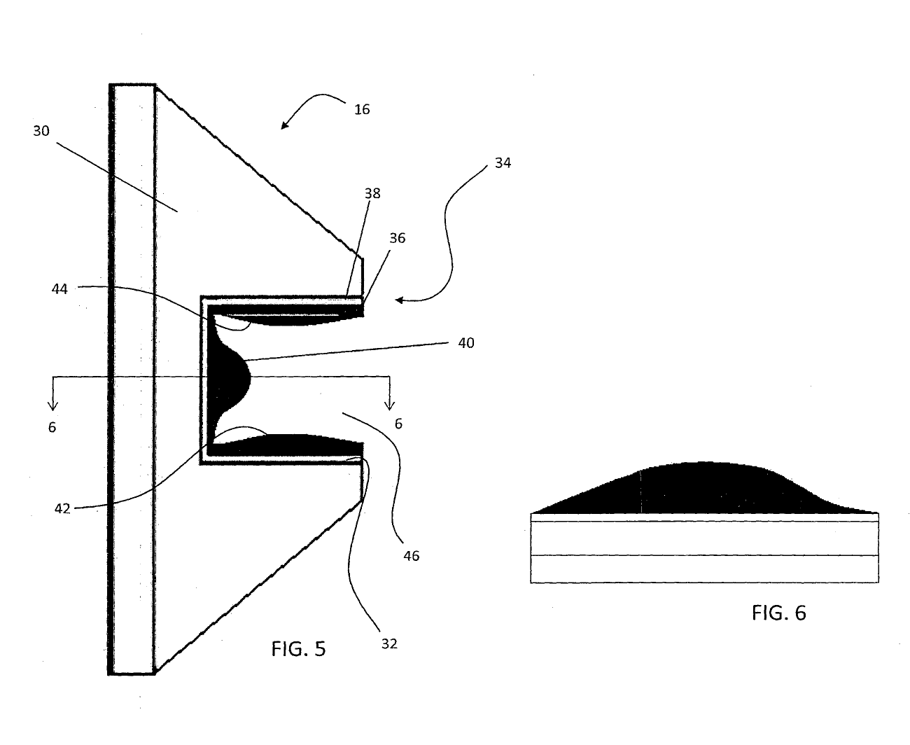

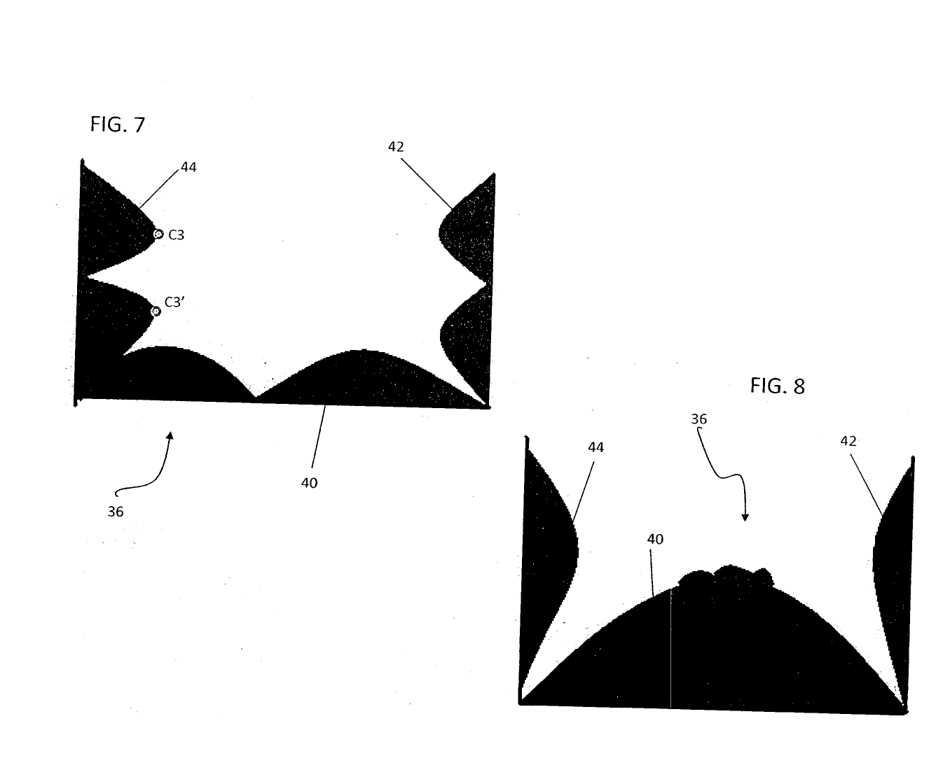

While the variable thickness of the walls 40, 42, 44 is described as creating a generally convex curvature, see FIGS. 3 and 4, alternative embodiments of the invention include a slide member liner 36 having walls with a non-symmetrical, and therefore a non-uniform curvature in a first direction and/or possible in a second direction. Referring to FIGS. 5 and 6, the non-uniform curvature may occur along any axis, including an axis perpendicular to the main axis of curvature such that the ends of the slide member liner 36 along the length of the sliding guide shoe 16 may have a gradual termination with respect to the guide rail 18. As illustrated in FIGS. 7 and 8, the non-uniform thickness of the walls 40, 42, 44, in either a first direction or a first and second direction, may result in at least one of the walls 40, 42, 44 contacting a respective surface 24, 26, 28 of the blade 22 at multiple locations. For example, if the slide member liner 36 illustrated in FIG. 7 has a uniform cross-section along its length, wall 44 will contact a respective surface of the blade 22 along multiple lines of contact C3. C3′. If a wall 40, 42, 44 of the slide member liner 36 has a non-uniform thickness in both the first direction and the second direction, the wall 40, 42, 44 may contact a respective surface 24, 26, 28 of the blade 22 at a plurality of contact areas. The plurality of contact areas may include both points and lines of contact.

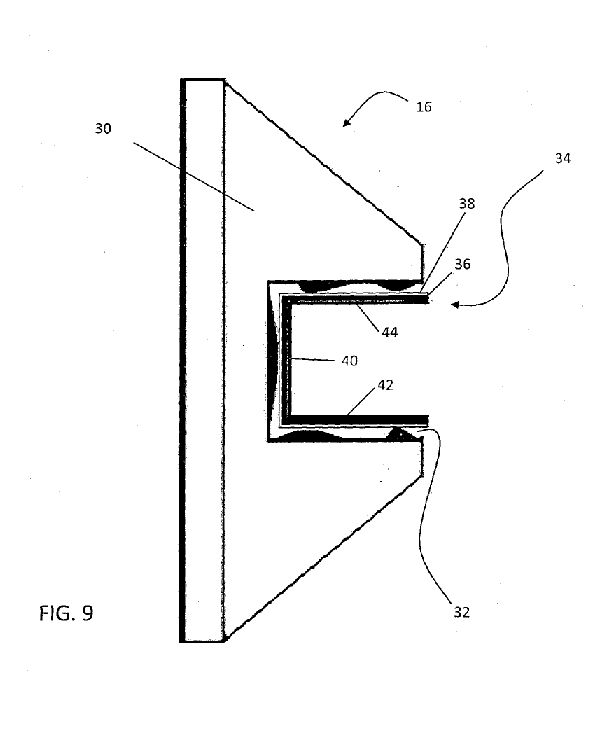

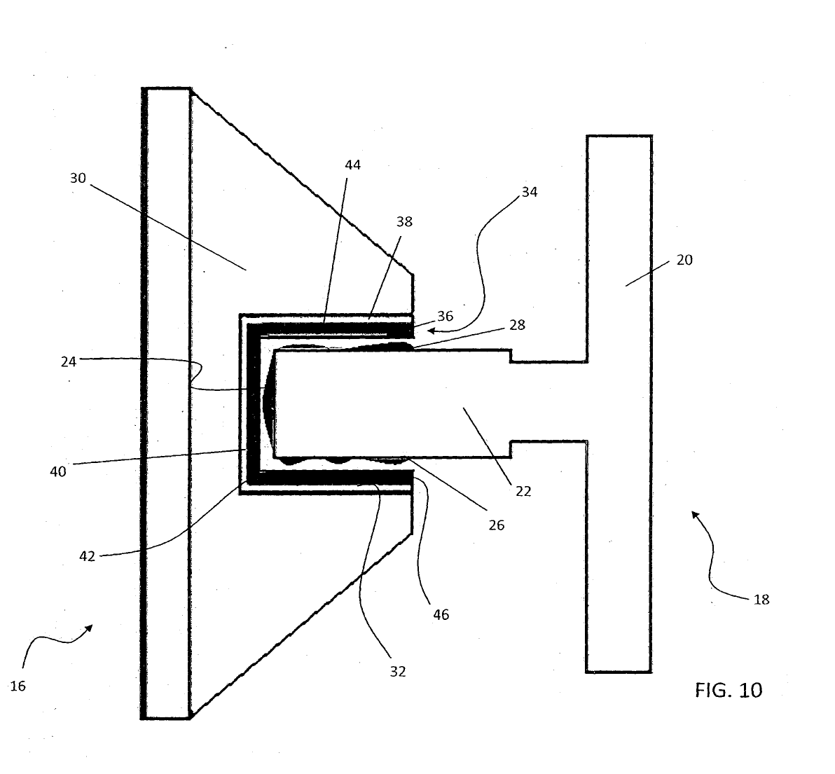

In another embodiment, the surfaces of the holding shoe 30 that define the longitudinal recess 32 within which the slide member 34 is received may have variable thicknesses (see FIG. 9). The slide member 34 may be contoured such that together, the slide member 34 and the holding shoe 30 form a desired shape that contacts a respective surface of the guide rail 18. The walls 40, 42, 44 of the slide member liner 36 may have a generally curved profile, complementary to the surfaces of the holding shoe, or alternatively, the walls 40, 42, 44 of the slide member liner 36 may have a generally uniform thickness. In one embodiment, the surfaces 24, 26, and 28 of the guide rail 18 may have a variable thickness so as to be generally curved (see FIG. 10). In such embodiments, the walls 40, 42, 44 of the slide member liner 36 may be generally flat and have a uniform thickness, or alternatively, the walls 40, 42, 44 of the slide member liner 36 may be curved to limit the area of contact between the walls 40, 42, 44 and the guide rail 18.

When more than one wall 40, 42, 44 of the slide member liner 36 has a varying thickness, for example the first sidewall 42 and the second sidewall 44, the profile of those walls may be the same or alternatively may be different for each of the walls. The profiles of each wall may be optimized based on friction and the life requirements of the slide member. In addition, the line(s) or point(s) of contact formed between each wall and a respective surface of the blade need not be co-planar. For example, the back wall 40 may have a profile uniform over the length of the slide member 34, as illustrated in FIG. 3, and the first sidewall 42 and the second sidewall 44 may have a profile uniform over the width of the slide member 34, as illustrated in FIG. 4.

A slide member 34 described herein having one or more walls 40, 42, 44 with a convex curvature may easily replace a slide member 34 in an existing system. By adding a curvature to walls 40, 42, 44 of the liner 36 or the holding shoe 30, the contact surface between the liner 36 and the blade 22 of the guide rail 18 is reduced. The decreased contact surface, and therefore decreased friction, between the sliding guide shoe 16 and the rail 18 reduces, or eliminates, the amount of lubricant required in the system 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A sliding guide shoe for an elevator, comprising:
a base comprising a plurality of walls;
a contact liner having a first side operably connected to at least one of the plurality of walls, and a second side configured to contact at least one surface of an elevator guide rail;
wherein the contact liner has a non-uniform thickness and is thereby configured to contact the at least one surface of the elevator guide rail over less than an entire surface of the second side of the contact liner.

2. The sliding guide shoe according to claim 1, wherein the contact liner is configured to contact the at least one surface of the elevator guide rail along a line.

3. The sliding guide shoe according to claim 1, wherein the contact liner is configured to contact the at least one surface of the elevator guide rail at a point, the point having an area that is less than 25% of the entire surface of the second side.

4. The sliding guide shoe according to claim 1, wherein the base is generally U-shaped.

5. The sliding guide shoe according to claim 1, further comprising a plurality of contact liners.

6. The sliding guide shoe according to claim 1, wherein the contact liner is curved in a plurality of directions.

7. The sliding guide shoe according to claim 6, wherein the contact liner is configured to contact at least one surface of the elevator guide rail at a plurality of contact areas.

8. The sliding guide shoe according to claim 1, wherein the first side of the contact liner is removably affixed to one of the plurality of walls of the base.

9. The sliding guide shoe according to claim 1, wherein at least one of the plurality of walls is curved in a first direction.

10. The sliding guide shoe according to claim 1, wherein at least one of the plurality of walls is curved in a plurality of directions.

11. An elevator system, comprising:
an elevator car;
at least one elevator guide rail along which the elevator car moves; and
a sliding guide shoe, operatively connected to the elevator car and configured to slide along the at least one elevator guide rail, the sliding guide shoe comprising:
a base having a plurality of walls;
a contact liner including a first side operably connected to at least one of the plurality of walls, and a second side configured to contact at least one surface of the elevator guide rail;
wherein the contact liner has a non-uniform thickness and is thereby configured to contact the at least one surfaces of the elevator guide rail over less than an entire surface of the second side of the contact liner.

12. The elevator system according to claim 11, wherein the contact liner is configured to contact the at least one surface of the elevator guide rail along a line.

13. The elevator system according to claim 11, wherein the contact liner is configured to contact the at least one surface of the elevator guide rail at a point, the point having an area that is less than 25% of the entire surface of the second side.

14. The elevator system according to claim 11, wherein the contact liner is curved in a plurality of directions.

15. The elevator system according to claim 11, wherein the contact liner is configured to contact at least one surface of the elevator guide rail at a plurality of contact areas.

16. The elevator system according to claim 15, wherein the first side of the contact liner is removably affixed to one of the plurality of walls of the base.

17. A slide member liner for sliding along a blade of a guide rail in an elevator hoistway, the slide member liner comprising:
a plurality of walls that define an interior recess therebetween for receiving the blade of the guide rail, wherein at least one of the plurality of walls has a non-uniform thickness such that only a portion of the at least one wall is configured to engage a surface of the blade.

18. The slide member liner according to claim 17, wherein the at least one wall is configured to engage a surface of the blade along a line.

19. The slide member liner according to claim 17, wherein the at least one wall is configured to engage a surface of the blade at a point.

20. The slide member liner according to claim 17, wherein the at least one wall is configured to engage a surface of the blade at a plurality of contact areas.
